(19) United States
(12) Patent Application Publication
(10) Pub. No.: US 2015/0153838 A1
(43) Pub. Date: Jun. 4, 2015

(54) INTEGRATED INPUT DEVICE AND METHOD THEREOF

(71) Applicants: INVENTEC CORPORATION, TAIPEI CITY (TW); INVENTEC (PUDONG) TECHNOLOGY CORPORATION, SHANGHAI (CN)

(72) Inventor: HUNG-SHENG WANG, Taipei City (TW)

(73) Assignees: INVENTEC CORPORATION, TAIPEI CITY (TW); INVENTEC (PUDONG) TECHNOLOGY CORPORATION, SHANGHAI (CN)

(21) Appl. No.: 14/244,724

(22) Filed: Apr. 3, 2014

(30) Foreign Application Priority Data
Nov. 29, 2013 (CN) 201310631707.8

(51) Int. Cl. G06F 3/02; G06F 3/041

(52) U.S. Cl. CPC G06F 3/021; G06F 3/041

(57) ABSTRACT

The disclosure provides an integrated input device and a method thereof. The integrated input device includes a sensing module and a keypad structure. The sensing module is configured to sense a relative position between an object and the sensing module so as to generate a corresponding key signal and/or a corresponding tracking signal. The keypad structure is disposed on the sensing module, and includes a frame and multiple restoring key units. The frame is disposed on the sensing module. The restoring key units is settled above the frame and configured to define a first reference distance and a second reference distance relative to the sensing module.

### CROSS-REFERENCE TO RELATED APPLICATIONS

This non-provisional application claims priority under 35 U.S.C. §119(a) on Patent Application No(s). 201310631707.8 filed in China on Nov. 29, 2013, the entire contents of which are hereby incorporated by reference.

### BACKGROUND OF THE INVENTION

1. Technical Field of the Invention

This disclosure relates to an integrated input device and a method thereof, and more particularly to an integrated input device and a method thereof including a touch panel and a keypad.

2. Description of the Related Art

Since the invention of the typewriter, keypad has been widely used in many devices. When users need to input any command to their computing devices, keypad is usually the most common tool in these devices. With the rapid development of integrated circuit technology, computing devices are becoming smaller in size and lighter in weight.

However, to accustom the using habit of users, the keypad on computing device becomes difficult to minimize.

Furthermore, laptops, in recent years, have another input device in touch panel other than the keypad. The touch panel inputs command to the laptop by detecting the contact and the action of the user's fingers on the touch panel. Since both the keypad and the touch panel usually take up significant amount space on laptop's structure, reducing the size of laptops has always been a tough task.

In summary, to effectively minimize the size of the keypad and touch panel have become the key to minimize the size of laptop or other devices with the input interface described above.

### SUMMARY OF THE INVENTION

The disclosure is to provide an integrated input device and method thereof, which integrates the keypad and the touch panel into one input device. The size will then be reduced significantly comparing to having the keypad and touch panel separately. Also, the integrated input device and method thereof has the structure to adapt to users' habits, so users may know clearly whether the key has been pressed or not. The integrated input device may define different corresponding actions with different pressing techniques and accidental triggering situations. Thus, the integrated input device may prevent the possible accidental triggering situations.

According to an embodiment, the integrated input device comprises a sensing module and a keypad structure. The sensing module is configured to detect a relative position information between an object relative and the sensing module so as to generate a key signal or a tracking signal corresponding to the relative position information. The key structure is disposed on the sensing module and further comprises a frame and a plurality of restoring key units. The frame is disposed above the sensing module. The restoring key units are located on the frame and are configured to define a first reference distance and a second relative distance between the object and the sensing module.

According to an embodiment, the integrated input method comprises the following steps. A plurality of keypad locations are defined based on a keypad structure. A first projected location of a first object on a sensing module and a first touch distance between the first object and the sensing module are detected. One of a key signal or a tracking signal is selectively generated according to the first projected location, the keypad locations, and the first touch distance.

### BRIEF DESCRIPTION OF THE DRAWINGS

The present disclosure will become more fully understood from the detailed description given herein below, along with the accompanying drawings which are for illustration only, thus are not limitative of the present disclosure, and wherein:

FIG. 1 is a partial top diagram of the integrated input device in an embodiment.

FIG. 2 is a partial cross-sectional diagram of the integrated input device in an embodiment.

FIG. 3 is a diagram of the pressing action on key unit in an embodiment.

FIG. 4 is a diagram of the pressing action on key unit in another embodiment.

FIG. 5 is a diagram of the operation on the integrated input device in an embodiment.

FIG. 6 is a diagram of the operation on the integrated input device in another embodiment.

FIG. 7 and FIG. 8 are diagrams of the operation on the integrated input device in an embodiment.

FIG. 9A is a flow chart of the integrated input method in an embodiment.

FIG. 9B is a flow chart of the step 930 (S930) in FIG. 9A.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing

According to the above-mentioned problems, the disclosure provides an integrated input device and method thereof for integrating a keyboard and a touch panel together, reducing the volume and area.

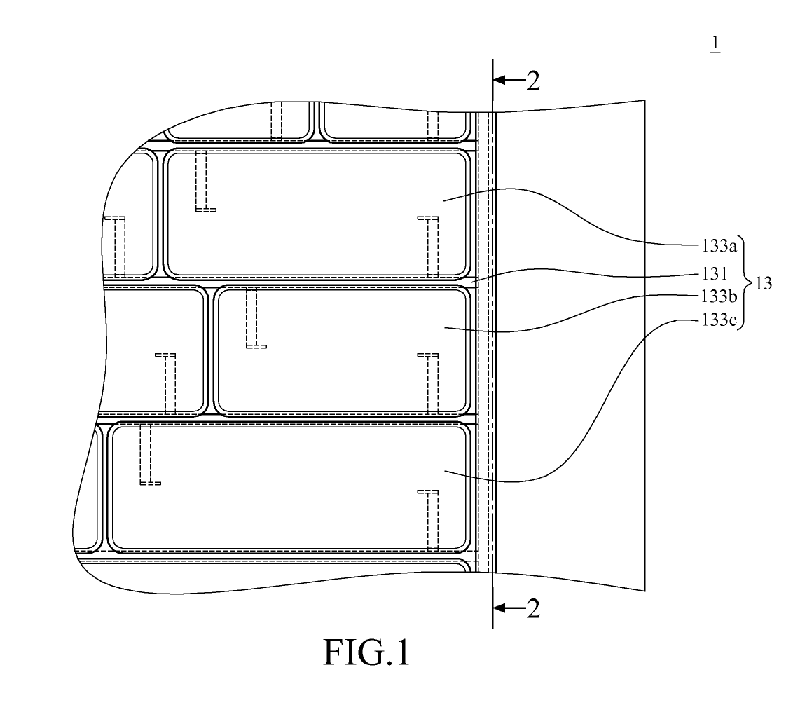

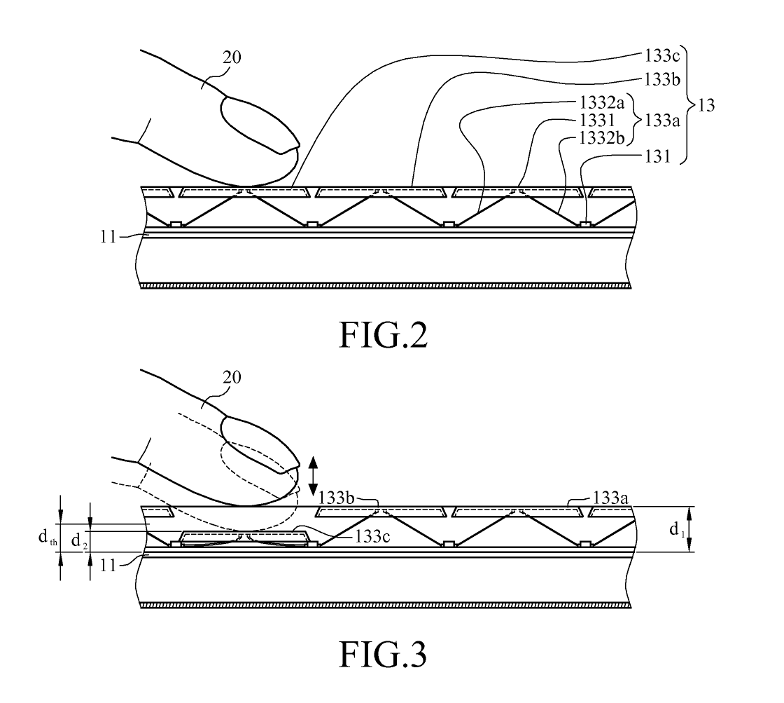

Referring to FIG. 1 and FIG. 2, FIG. 1 is a partial top diagram of the integrated input device in an embodiment; FIG. 2 is a partial cross-sectional diagram of the integrated input device in an embodiment. As shown in FIG. 2, the integrated input device 1 comprises a sensing module 11 and a keypad structure 13. The keypad structure 13 is disposed above the sensing module 11.

The sensing module 11 is configured to detect a relative position information between an object and the sensing module 11 so as to generate a key signal or a tracking signal corresponding to the relative position information. The object may be users' fingers or any devices that are used for operating the integrated input device, e.g., a stylus. For example, the sensing module 11 may be a projected capacitive touch panel. The projected capacitive touch panel may detect the distance between the user's finger(s) and the projected capacitive touch panel, so the user may use one or several fingers to generate different input signals to the projected capacitive touch panel. The sensing module 11 in this disclosure may be a projected capacitive touch panel, a sound wave touch panel, or any other touch panel that can detect the distance of the user's fingers. The disclosure is not limited thereto.

The keypad structure 13 of an embodiment comprises a frame 131 and a plurality of restoring key units 133a-133c. Referring to FIG. 3, FIG. 3 is a diagram of the pressing action on key unit in an embodiment. As shown in FIG. 3, each of the restoring key units may be configured to define a first reference distance D1 and a second reference distance D2. The first reference distance D1 is the distance between the object and the sensing module 11 when the object (finger) naturally contacts the restoring key unit. The second reference distance D2 is the distance between the object and the sensing module 11 when the object presses the restoring key unit forcefully. The frame 131 is disposed above the sensing module 11 and is configured to stabilize the horizontal position of the restoring key units. Thus, the keypad structure 13 may define the keypad locations, the first reference distance, and the second reference distance. When a user operates the integrated input device 1 of the disclosure, the user may know clearly which key unit is being pressed and whether or not the key unit being pressed may be identified by the integrated input device 1.

In an embodiment, each of the restoring key units may comprise a keycap, a first spring sheet, and a second spring sheet. For restoring key unit 133a, the restoring key unit 133a comprises a keycap 1331, a first spring sheet 1332a, and a second spring sheet 1332b. The first side of the first spring sheet 1332a and the first side of the second spring sheet 1332b are connected to the keycap 1331. The second side of the first spring sheet 1332a and the second side of the second spring sheet 1332b are connected to the frame 131. Therefore, each of the restoring key units may be in the natural status shown in FIG. 2 when no external force is exerted, thereby defining the first reference distance D1. Taking the restoring key unit 133c as an example, when there is an object (finger) presses the restoring key unit 133c, the restoring key unit 133c may be pressed to define the second reference distance D2. In an embodiment, the restoring key units and the frame may be made of insulation material and integrally formed with each other (i.e., into a single unit). According to the disclosure, the restoring key units may not be limited to comprise spring sheet. Any other method or device that can recover the position of the keycap may all be used.

The method of the sensing module 11 detecting a relative position information between an object and the sensing module so as to generate a key signal or a tracking signal is described below. The sensing module 11 may detect the distance between one or more objects (such as finger(s)) and the sensing module 11. When the touch distance Dt between the object and the sensing module 11 is smaller than the threshold distance Dth, the sensing module 11 first finds out the projected location of the object relative to the specific key unit on the keypad structure 13 according to a stored keypad list. Then, the specific restoring key unit, that is being pressed, may then be correctly determined so that the key signal is selectively generated. The threshold distance Dth is between the value of the first reference distance D1 and the second reference distance D2. In an embodiment, the threshold distance Dth may be the average value between the first reference distance D1 and the second reference distance D2. In another embodiment, the threshold distance Dth may be the second reference distance D2 plus an error tolerance range Derr. Moreover, in an embodiment, no matter whether the key unit is pressed or not, the sensing module 11 may detect the position and the movement of one or more objects and selectively generate the tracking signal.

Referring back to FIG. 2, when an object 20 (finger) is softly disposed on the restoring key unit 133c, the sensing module 11 detects that the touch distance Dt between the object 20 and the sensing module 11 is approximately the first reference distance Dl. Therefore, since the restoring key unit 133c is not being pressed and the object does not have any other action, the sensing module 11 does not generate the key signal nor the tracking signal.

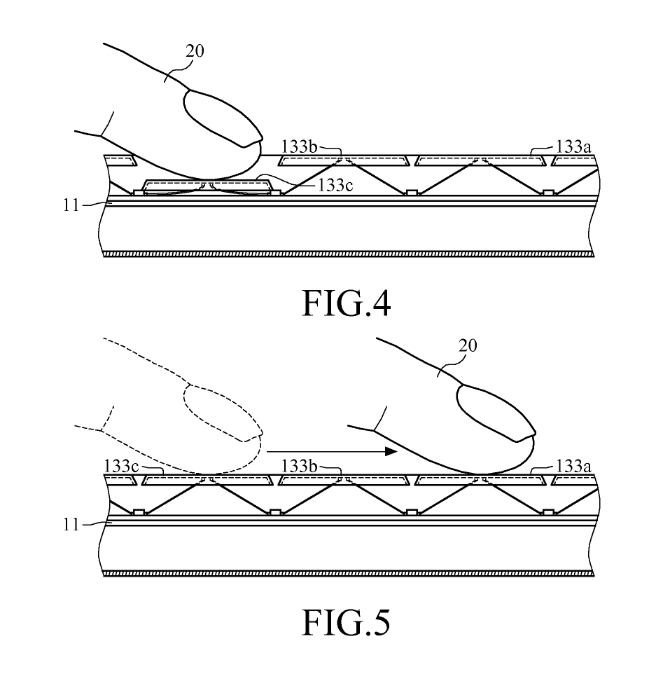

In an embodiment, referring to FIG. 3 and FIG. 4, FIG. 4 is a diagram of the pressing action on key unit. The object 20 may quickly press and let go the restoring key unit 133c, as shown in FIG. 3. The object also may continuously press the restoring key unit 133c, as shown in FIG. 4. However, for some restoring key units, users may not continuously press on them to output the same command corresponding to the key unit, such as symbols, letters, or some specific commands. Also, for some other restoring key units like space key, delete key, direction key, or backspace key, users usually may continuously press on these keys to repeatedly output the command corresponding to the key unit. Thus, when the sensing module 11 detects an object 20 pressing a restoring key unit, the sensing module 11 may first send out the command corresponding to the pressed key unit, and then detect the time interval of which the restoring key unit is pressed.

If the press time interval is larger than a threshold time interval, then the capacitance module 11 may determine whether or not to repeatedly send out the command according to the restoring key unit being pressed. For example, when the pressed key unit is a space key, backspace key, direction key, delete key, or keys that are defined to be pressed continuously, then the sensing module 11 may repeatly send out the command of the corresponding restoring key unit.

When the pressed key unit is a letter key, number key, insert key, Caps Lock key, Num Lock key, or keys that are defined to not be pressed continuously or repeatedly, the sensing module 11 may only send out the command once, rather than continuously send out the command corresponding to the restoring key unit.

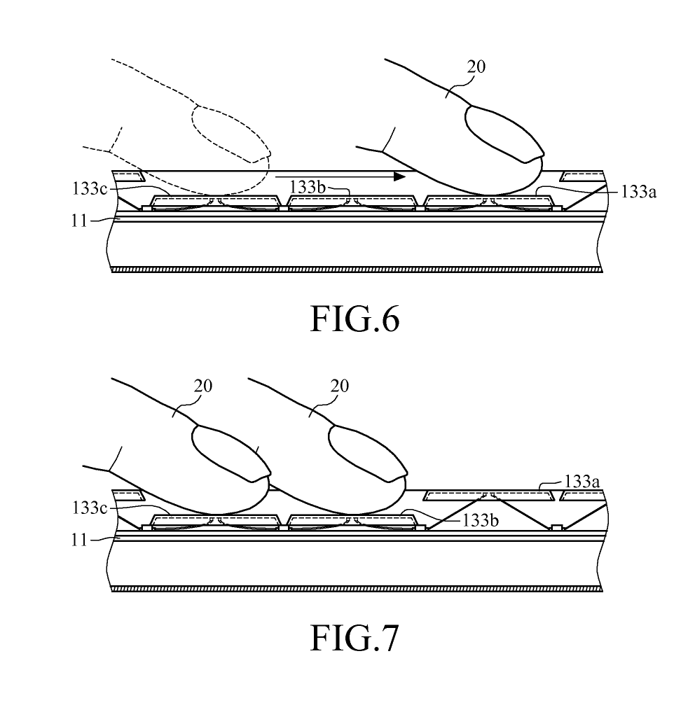

In another embodiment, referring to FIG. 5 and FIG. 6, FIG. 5 is a diagram of the operation on the integrated input device; FIG. 6 is a diagram of the operation on the integrated input device. As shown in FIG. 5, the object 20 (finger) may softly contact the restoring key unit and also move on the surface of the restoring key unit without pressing it. Since the distance between the object 20 and the sensing module 11 is longer than the threshold distance Dth illustrated above, the sensing module 11 detects that the object 20 does not perform the action of pressing the restoring key unit. Meanwhile, since the projected location of the object 20 projected on the sensing module 11 changes, the sensing module 11 then outputs the corresponding tracking signal according to the change of the projected location of the object 20. For example, the integrated input device 1 may then send out a tracking signal for moving the mouse cursor.

As shown in FIG. 6, the object 20 (finger) presses the restoring key unit and then moves. Since the touch distance Dt between the object 20 and the sensing module 11 is smaller than the threshold distance Dth described above, the sensing module 11 will detect that the object 20 performed the action of pressing the restoring key unit. Also, since the projected location of the object 20 projected on the sensing module 11 changes, the sensing module 11 may output the corresponding tracking signal according to the change of the projected location of the object 20. Since the tracking signal is outputted, the sensing module 11 does not generate the key signal according the keypad list when the object 20 performs the action of pressing the restoring key unit. Instead, the key signal that corresponds to the mouse key is generated. Thus, users may then notice the objects shown on the monitor, such as folders being clicked or moved.

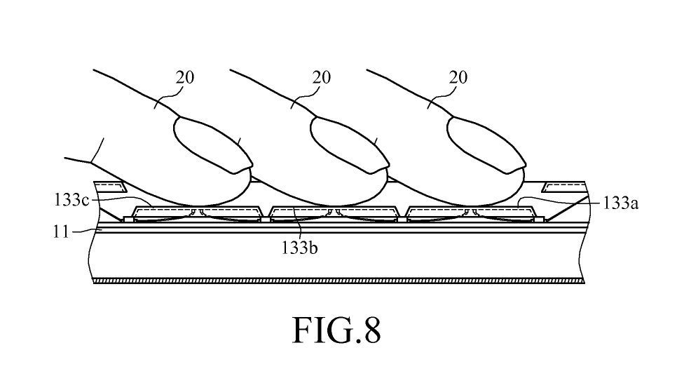

In an embodiment, referring to FIG. 7 and FIG. 8, FIG. 7 and FIG. 8 are diagrams of the operation on the integrated input device. As shown in FIG. 7, when the sensing module 11 detects that two restoring key units are being pressed by the object 20, the sensing module 11 may determine, according to the keypad list, whether or not there are key signals that correspond to the pressed restoring key units. For example, when the two restoring key units pressed are shift key and letter ‘A’ key, capital letter ‘A’ will be outputted. Another example, When the two restoring key units pressed are letter ‘C’ key and letter ‘A’ key, nothing will be outputted since there are no corresponding key signal to the two key units being pressed together according to the keypad list. However, new commands of key units being pressed together can be added by users to the keypad list of the sensing module 11.

As shown in FIG. 8, the sensing module 11 detects that three restoring key units are being pressed, so the sensing module 11 may determine, according to the keypad list, whether or not there are key signals that correspond to the pressed restoring key units For example, when the three restoring key units being pressed are ‘Ctrl’ key, ‘Alt’ key, and ‘Del’ key, the reboot command will then be outputted. Also, since it is unlikely that three restoring key units, close with each other, are pressed at the same time (for example, ‘A’, ‘S’, and ‘W’ keys), which may be occurred by being inadvertently touched, the sensing module 11 may not output any key signal or tracking signal when three restoring key units close by are pressed together.

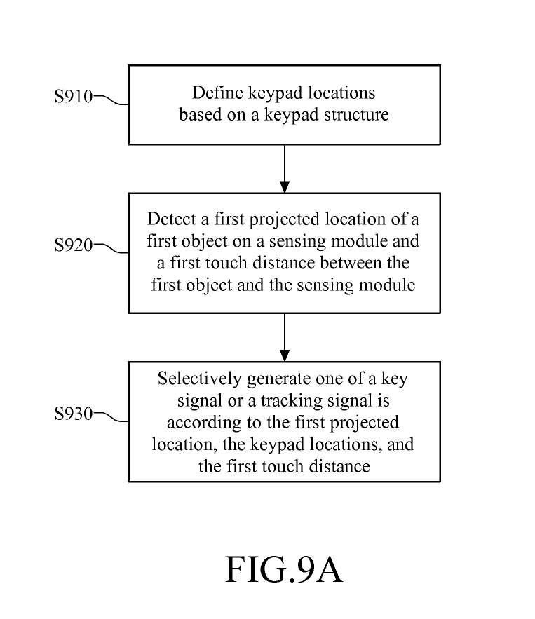

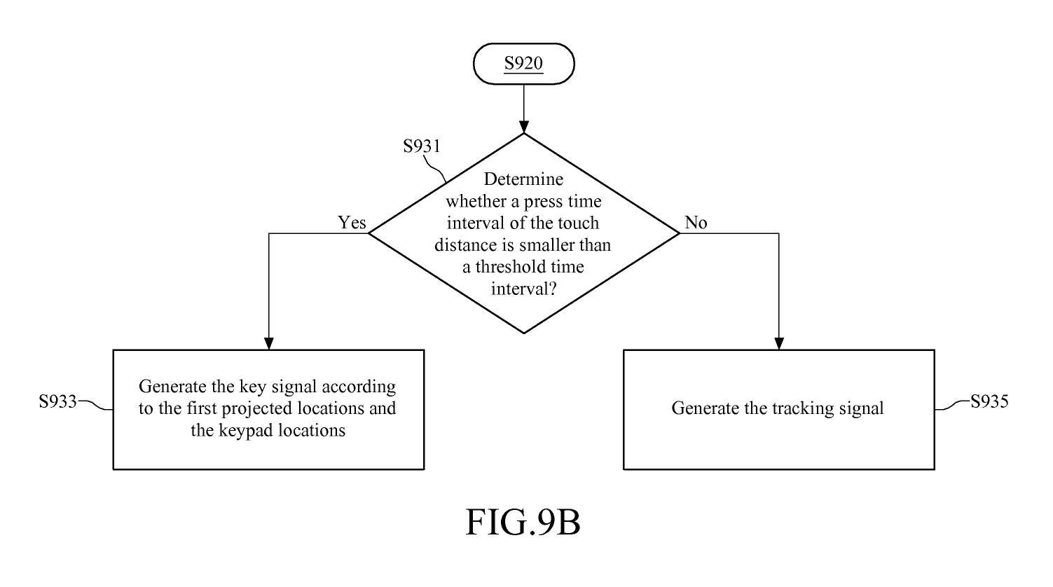

In summary, the integrated input device illustrated above applies an integrated input method. Referring to FIG. 9A, FIG. 9A is a flow chart of the integrated input method in an embodiment. In Step 910 (S910), a plurality of keypad locations are defined based on a keypad structure. In Step 920 (S920), a first projected location of a first object on a sensing module and a first touch distance between the first object and the sensing module are detected. In Step 930 (S930), one of a key signal or a tracking signal is selectively generated according to the first projected location, the keypad locations, and the first touch distance.

In another embodiment, referring to FIG. 9B, FIG. 9B is a flow chart of the step 930 (S930) in FIG. 9A. In Step 931 (S931), whether a press time interval of the touch distance is smaller than a threshold time interval is determined. When the press time interval is smaller than the threshold time interval, then the key signal may be generated according to the first projected locations and the keypad locations, as shown in Step 933 (S933). When the press time interval is not smaller than the threshold time interval, then the tracking signal may be generated, as shown in Step 935 (S935).

In summary, the integrated input device and method thereof of the disclosure combines the keypad and the touch panel in computing devices, so the size of the computing devices may be reduced significantly comparing to having the keypad and the touch panel separately. Moreover, the integrated input device has a keypad structure that can adapt to the users' habit, so that the users can know clearly whether the key unit has been pressed or not. The integrated input device may also define different corresponding actions with different pressing techniques and accidental triggering situations. Thus, the integrated input device may prevent the possible accidental triggering situations.

What is claimed is:

1. An integrated input device, comprising:
a sensing module, configured to detect a relative position information between an object and the sensing module so as to generate a key signal or a tracking signal corresponding to the relative position information; and
a keypad structure, disposed above the sensing module, the keypad structure comprising:
a frame, disposed above the sensing module; and
a plurality of restoring key units, located on the frame and configured to define a first reference distance and a second reference distance relative to the sensing module.

2. The integrated input device according to claim 1, wherein each of the restoring key units comprises a keycap, a first spring sheet and a second spring sheet, a first side of the first spring sheet and a first side of the second spring sheet are connected to the keycap, and a second side of the first spring sheet and a second side of the second spring sheet are connected to the frame.

3. The integrated input device according to claim 2, wherein the relative position information comprises:
a touch distance between the object and the sensing module; and
a projected location of the object projected on the sensing module.

4. The integrated input device according to claim 2, wherein the frame and the restoring key units are integrally formed with each other.

5. The integrated input device according to claim 2, wherein the frame and the restoring key units are made of insulation material.

6. A integrated input method, comprising:
defining a plurality of keypad locations based on a keypad structure;
detecting a first projected location of a first object on a sensing module and a first touch distance between the first object and the sensing module; and
selectively generating a key signal or a tracking signal according to the first projected location, the keypad locations, and the first touch distance.

7. The integrated input method according to claim 6, further comprising:
defining a first reference distance between the object and the sensing module, and a second reference distance between the object and the sensing module based on the keypad structure, wherein the first reference distance is longer than the second reference distance, and one of the key signal and the tracking signal is selectively generated according to the first reference distance and the second reference distance.

8. The integrated input method according to claim 6, further comprising:
detecting a second projected location of a second object on the sensing module and a second touch distance between the second object and the sensing module, and one of the key signal and the tracking signal is selectively generated according to the second projected location and the second touch distance.

9. The integrated input method according to claim 6, wherein the step of selectively generating the key signal or the tracking signal according to the first projected location, the keypad locations, and the first touch distance further comprises:
determining whether a press time interval of the first touch distance is smaller than a threshold time interval, wherein the first touch distance is smaller than a threshold distance;
generating the key signal if the press time interval is smaller than the threshold time interval; and
generating the tracking signal if the press time interval is not smaller than the threshold time interval.
